(19) United States
(12) Patent Application Publication
(10) Pub. No.: US 2024/0190162 A1
(43) Pub. Date: Jun. 13, 2024

(54) PROCESS FOR APPLYING RESINOUS FLUIDS FOR CAST MICRO-OPTIC STRUCTURES MANUFACTURING

(71) Applicant: Crane & Co., Inc., Dalton, MA (US)

(72) Inventor: Paul F. Cote, Barnstead, NH (US)

(21) Appl. No.: 18/556,429

(22) PCT Filed: Apr. 22, 2022
(86) PCT No.: PCT/US2022/071877

§ 371 Date: Oct. 20, 2023

Related U.S. Application Data
(60) Provisional application No. 63/178,844, filed on Apr. 23, 2021.

(51) Int. Cl. B42D 25/387; B42D 25/328; B42D 25/48; G02B 3/00

(52) U.S. Cl. CPC B42D 25/387; B42D 25/328; B42D 25/48; G02B 3/0031

(57) ABSTRACT

A method of cast curing microstructures of a micro-optic security device includes jetting a first volume of a first radiation-curable resin directly onto a casting master to form a layer of the first radiation-curable resin having a first thickness, bringing the casting master into contact with a substrate along a squeeze line to transfer the first radiation-curable resin to the substrate and applying curing radiation to the transferred first radiation-curable resin.

### CROSS-REFERENCE TO RELATED APPLICATION(S) AND CLAIM OF PRIORITY

This application is a 371 National Stage of International Application No. PCT/US2022/071877, filed Apr. 22, 2022, which claims priority to U.S. Provisional Patent Application No. 63/178,844, filed Apr. 23, 2021, the disclosures of which are incorporated herein by reference.

### TECHNICAL FIELD

The present disclosure relates to the production of cast micro-optic structures, including, without limitation, micro-lenses, micro-reflectors, and diffraction gratings. More specifically, this disclosure relates to improved processes for applying casting media (for example, radiation-curable resinous fluids) used to manufacture micro-optic structures.

### BACKGROUND

Hardening passports, banknotes and other documents (referred to herein as “security documents”) whose constructional features include hard-to-reproduce indicia of the documents' authenticity against counterfeiting remains an ongoing source of technical challenges and opportunities for improvement in the field of security document design. Micro-optic devices, such as holograms, gratings providing color shifts and other optical effects, and synthetic magnifiers, through which a layer of icon material is viewed through an array of thousands or millions of small-scale microlenses (for example, lenses on the order of 50 micrometers in diameter), to produce an image that is dynamic (i.e., its appearance can change with viewing angle) and has the appearance of three-dimensionality, constitute popular and effective forms of hard-to-reproduce indicia of authenticity. Such micro-optic devices are typically produces by casting a casting medium (for example, a radiation-curable polymer) against a casting master with a relief structure corresponding to the lenses and other optical structures of the micro-optic devices. The tiny scale of the relief structures on the casting masters presents significant manufacturing challenges, making the reproduction of casting masters extremely difficult, if not impossible for counterfeiters and other malicious actors.

However, the tiny scale of the relief structures and the nature of the casting media used to produce the above-described micro-optic also presents technical challenges for legitimate manufacturers of micro-optic devices. Traditionally, micro-lenses and other optical structures of micro-optic security devices are produced by coating or transferring continuous layer of casting medium (for example, a UV-curable resin) to a film substrate and then pressing the coated substrate against a casting master. Typically, UV light is used to cure the resin while the coated substrate and master are in contact, causing the resin to cross-link and form a negative of the relief structure of the casting master.

Oxygen inhibition during curing presents chronic technical challenge associated with the above-described method. The presence of oxygen in the casting medium can retard or inhibit cross-linking of photoreactive polymer chains in the casting medium, resulting in pockets of uncured or partially cured casting medium, which is softer, and in some cases, more tacky than fully cured casting medium. Being tacky, partially cured casting medium sticks to the casting master when the substrate is peeled from the casting master following curing, resulting in “dead spots” and other unwanted defects in the micro-optic casting.

Where a rotating, cylindrical casting master is used (for example, as part of a continuous web manufacturing process), air bubbles can be trapped in a wave of resin formed between the casting master and substrate at a pinch point, where the substrate is brought into contact with the roller-style casting master. The bubbles can tumble in the wave of resin, wherein some bubbles become entrapped between the master and substrate. The resin in the area of the trapped bubbles may be susceptible to oxygen inhibition, which can result in tackiness (causing material to stick to the casting master) or regions of comparatively fragile material in the cast micro-structures. Both of these are undesirable. Failure of the cast substrate to fully separate from the casting master can result in both a defect in the cast substrate, as well as a repeating defect in subsequent castings, as the unseparated material remains in the casting master, causing casting defects in subsequent castings. Additionally, accumulation of uncured or partially cured casting medium can cause further turbulence in the wave of resin, causing the accumulation of uncured or partially cured casting medium on the casting master to snowball, forcing operation to stop for cleaning the casting master.

Accordingly, mitigating oxygen inhibition during the casting of micro-structures remains a source of technical challenges and opportunities for improvement in the art.

### SUMMARY

The present disclosure illustrates embodiments of improved processes for applying resinous fluids for cast micro-optic structures manufacturing.

In a first embodiment, a method of cast curing microstructures of a micro-optic security device according to present disclosure include methods including jetting a first volume of a first radiation-curable resin directly onto a casting master to form a layer of the first radiation-curable resin having a first thickness, bringing the casting master into contact with a substrate along a squeeze line to transfer the first radiation-curable resin to the substrate and applying curing radiation to the transferred first radiation-curable resin.

In a second embodiment, an apparatus for cast curing microstructures of a micro-optic security device according to present disclosure includes a jet dispenser configured to dispense a first radiation-curable resin directly onto a casting master and a controller communicatively connected to the jet dispenser, wherein the controller is configured to control the jet dispenser to dispense a first volume of the first radiation-curable resin directly onto the casting master to form a layer of the first radiation-curable resin having a first thickness.

In a third embodiment, a micro-optic security device, the micro-optic security device includes a substrate and one or more layers of cast-cured microstructures on the substrate, wherein the one or more layers of cast-cured microstructures a first region of cast-cured micro-structures formed of a first cured radiation-curable resin, wherein the cast-cured micro-structures in the first region are free of one or more of voids, tacky spots, or other products of oxygen inhibition.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a micro-optic security device incorporating one or more precision-cast layers according to various embodiments of this disclosure;

FIGS. 2A-2D illustrate aspects of an example method for precision-casting micro-optic structures according to various embodiments of this disclosure;

FIGS. 3A-3B illustrates examples of apparatuses for applying casting media to a casting master according to certain embodiments of this disclosure; and

FIG. 4 illustrates an example of an example system architecture for an apparatus for precision application of casting media to a casting master according to some embodiments of this disclosure.

### DETAILED DESCRIPTION

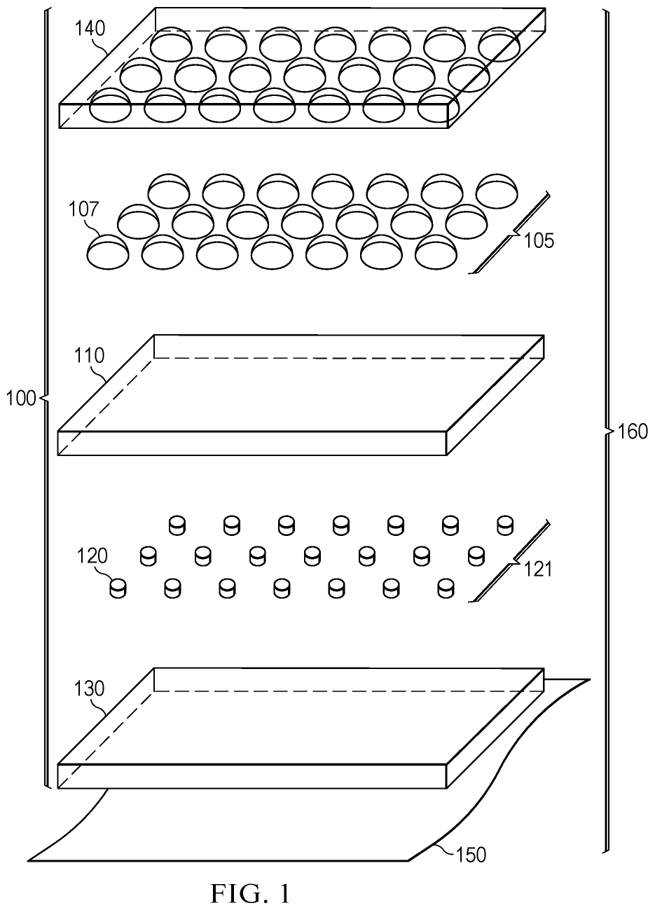

FIGS. 1 through 4, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged security document.

Although the present disclosure has been described with various embodiments, various changes and modifications may be suggested to one skilled in the art. It is intended that the present disclosure encompass such changes and modifications as falling within the scope of the claims.

FIG. 1 illustrates an example of a section of an optical security device 100, utilizing cast micro-optic structures formed using methods according to certain embodiments of this disclosure.

Referring to the non-limiting example of FIG. 1, optical security device 100 comprises, a plurality of cast focusing elements 105 (including, for example, focusing element 107), and an arrangement of cast image icons 121 (including, for example, image icon 120). According to various embodiments, each focusing element of plurality of focusing elements 105 has a footprint, in which one or more image icons of arrangement of image icons 121 is positioned. According to various embodiments, each focusing element of plurality of focusing elements 105 has a diameter on the order of 50 μm, with some embodiments having diameters of 25 μm or less. Collectively, the focusing elements of plurality of focusing elements 105, magnify portions of image icons 121 to produce a moiré magnification effect (also referred to as a “synthetically magnified image” or more briefly, a “synthetic image”) wherein the individually microscopic image icons are collectively magnified by the plurality of focusing elements 105 to produce an image which dynamically reacts (for example, by appearing to move, or change colors) to shifts in viewing angle. Given the small scale and tight manufacturing tolerances of the constituent structures of optical security device providing the moiré magnification effect, many malicious actors are not able to produce counterfeit versions of optical security device 100. In certain embodiments, one or more of focusing elements 105 or image icons 121 are formed through casting a resinous casting media between a casting master and a substrate. In cases where the casting media is only applied to the substrate prior to casting and curing, there is a risk of oxygen inhibition retarding or inhibiting curing of the casting media, which can produce the previously described problems of tacky spots in the cured product and progressive crudding of the casting master with partially cured casting media.

According to certain embodiments, plurality of focusing elements 105 comprises a planar array of micro-optic focusing elements. In some embodiments, the focusing elements of plurality of focusing elements 105 comprise micro-optic refractive focusing elements (for example, plano-convex or GRIN lenses). Refractive focusing elements of plurality of focusing elements 105 are, in some embodiments, produced from light cured resins with indices of refraction ranging from 1.35 to 1.7, and have diameters ranging from 5 μm to 200 μm. In various embodiments, the focusing elements of plurality of focusing elements 105 comprise reflective focusing elements (for example, very small concave mirrors), with diameters ranging from 5 μm to 50 μm. While in this illustrative example, the focusing elements of plurality of focusing elements 105 are shown as comprising circular plano-convex lenses, other refractive lens geometries, for example, lenticular lenses, are possible and within the contemplated scope of this disclosure.

As shown in the illustrative example of FIG. 1, arrangement of image icons 121 comprises a set of image icons (including image icon 120), positioned at predetermined locations within the footprints of the focusing elements of plurality of focusing elements 105. According to various embodiments, the individual image icons of arrangement of image icons 121 comprise regions of light cured material associated with the focal path of structured light (for example, collimated UV light) passing through plurality of focusing elements 105 from a projection point associated with one or more predetermined ranges of viewing angles. In some embodiments, the individual image icons of arrangement of image icons 121 are not provided within a structured image icon layer. As used in this disclosure, the term “structured image layer” encompasses a layer of material (for example, a light-curable resin) which has been cast to comprise structures (for example, recesses, posts, grooves, or mesas) for positioning and retaining image icon material. According to various embodiments, the individual image icons of arrangement of image icons 121 are provided within a structured image layer, the structured image layer comprising one or more of voids, mesas, or posts, which act as retaining structures to hold micro- and nano-scale volumes of colored material.

As shown in the illustrative example of FIG. 1, in certain embodiments, optical security device 100 includes an optical spacer 110. According to various embodiments, optical spacer 110 comprises a film of substantially transparent material which operates to position image icons of arrangement of image icons 121 in or around the focal plane of focusing elements of plurality of focusing elements 105. In certain embodiments according to this disclosure, optical spacer 110 comprises a manufacturing substrate upon which one or more layers of light curable material can be applied, to form one or more of arrangement of image icons 121 or plurality of focusing elements 105.

According to various embodiments, optical security device 100 comprises one or more regions of light-cured protective material which occupy the spaces between the image icons of arrangement of image icons 121. In some embodiments, the arrangement of image icons 121 is first formed and then a layer of clear, light-curable material is applied to fill spaces between the image icons of arrangement of image icons 121 and then flood-cured to create a protective layer, which protects the image icons from being moved from their positions within the footprints of focusing elements of plurality of focusing elements 105. In certain embodiments, the light-curable material used to form arrangement of image icons 121 is a pigmented, ultraviolet (UV)-curable polymer.

In some embodiments, arrangement of image icons 121 is affixed to a second substrate 130, which operates to protect and secure arrangement of image icons 121 and provide an interface for attaching optical security device 100 to a substrate 150 as part of a security document.

In certain embodiments according to this disclosure, optical security device 100 comprises a seal layer 140. According to certain embodiments, seal layer 140 comprises a thin (for example, a 2 μm to 50 μm thick layer) of substantially clear material which interfaces on a lower surface, with focusing elements of the plurality of focusing elements 105, and comprises an upper surface with less variation in curvature (for example, by being smooth, or by having a surface whose local undulations are of a larger radius of curvature than the focusing elements) than the plurality of focusing elements 105. According to various embodiments, the upper surface of seal layer 140 is formed from a thermoplastic material which can be ultrasonically welded to a surface comprising a cellulosic material.

As shown in the non-limiting example of FIG. 1, in certain embodiments, optical security device 100 can be attached to substrate 150, to form a security document 160. According to various embodiments, substrate 150 comprises a sheet of material with at least one surface comprising cellulosic material, such as wood pulp, cotton fiber, linen fiber, flax fiber, sisal fiber, hemp fiber, Abaca fiber, Kozo fiber, Mitsumata fiber, bamboo fiber or Kenaf fiber.

While FIG. 1 provides one example of an optical security device 100 according to various embodiments, the present disclosure is not so limited. Other optical security devices which comprise at least one surface with hard-to-reproduce cast micro- and nano-scale optical structures (for example, holograms, devices providing thin-film effects, devices producing diffraction-based optical effects) are within the contemplated scope of this disclosure.

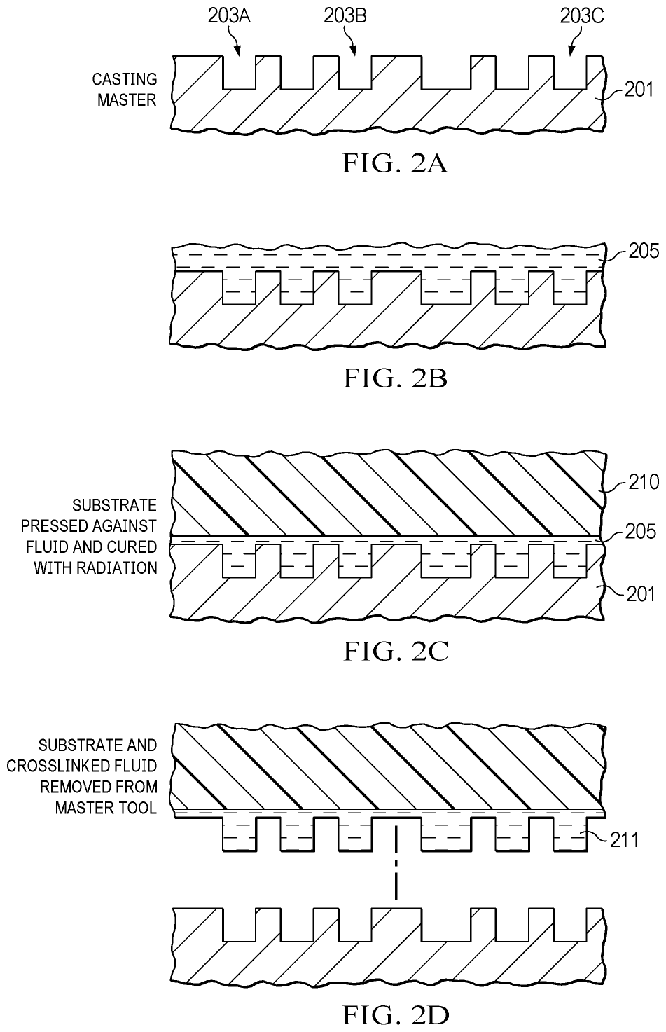

FIGS. 2A-2D illustrates aspects of an example process for casting a radiation-curable casting medium according to various embodiments of this disclosure. For ease of cross-reference, elements common to more than one or FIGS. 2A-2D are numbered similarly.

Referring to the non-limiting example of FIG. 2A, a section 201 of a casting master for casting micro-structures is shown in the figure. According to certain embodiments, the casting master is a cylindrical master which rotates during operation, as part of a continuous web manufacturing process. In certain embodiments, the casting master comprising section 201 may be a flat casting master. As shown in FIG. 2A, section 201 comprises a plurality of relief structures (for example, relief structures 203A-203C). In certain embodiments, each relief structure of the plurality of relief structures has a relief profile which is a negative of the relief of one or more micro-optic structures of the security device (for example, focusing element 107) or image icon 120. In certain embodiments, the relief structures of the casting master of a sufficiently small scale (for example, with widths of 50 μm or less and depths of 10 μm) or less, that the casting master is created using proprietary micro-fabrication techniques similar to those used to produce integrated circuit chips. As practicing such micro-fabrication techniques requires specialized equipment, capital and expertise, malicious actors are not able to replicate the casting masters used to produce cast micro-optic security devices, making such security devices an effective indicia of the authenticity of documents and products on which they appear. When pressed into a retained volume of casting media, such as a radiation-curable resin. Examples of radiation-curable polymeric resins which are suitable for use as casting media include without limitation, isodecyl trimethylolpropane triacrylate, and hexanediol diacrylate. Further examples of materials suitable for use as casting media include transparent or clear, colored or colorless polymers such as acrylics, acrylated polyesters, acrylated urethanes, epoxies, polycarbonates, polypropylenes, polyesters and urethanes. Still further examples of materials suitable for use as casting media include, without limitation, acrylate monomers, acrylate oligomers, O-phenlyphenoxyethyl acrylate, phenylthioethyl acrylate, bis-phenylthioethyl acrylate, cumin phenoxyl ethyl acrylate, a biphenylmethyl acrylate, bisphenol A epoxy acrylates, fluorene-type acrylates, brominated acrylates, halogenated acrylates, melamine acrylates and combinations thereof. As shown in FIG. 2B, the casting media is applied such that it fills the relief structures of section 201.

As noted elsewhere in this disclosure, traditionally, casting media is introduced to casting masters indirectly, by first applying a layer of casting media to a layer of film (for example, polyethylene terephthalate (PET) film used to form an optical spacer 110 in FIG. 1) to form a layer of uncured casting media at a depth corresponding to a specified volume per unit area. Typically, when casting media is applied to a substrate prior to casting, it is applied at a volume per unit area sufficient to ensure that the casting master is fully wetted in the areas where the relief structure is deepest or otherwise requires the most casting media. Coating the substrate to ensure wetting of the deepest, or “thirstiest” portion of the casting master necessarily requires applying more casting media than necessary to fill remaining portions of the casting master. As such, when the casting master is brought into contact with the layer of casting media on the substrate, and pressed into the casting media to fill the deepest recesses of the casting master, excess casting media in the portions of the casting master with shallower relief is squeezed out, which can form a standing wave of uncured casting medium near the “pinch point” where the casting master presses into the standing layer of uncured casting medium. This standing wave of uncured excess casting medium may be undesirable for at least the following reasons. First, applying more casting medium than necessary is, by definition, wasteful, which is undesirable for large-scale manufacturing operations in competitive fields. Second, as discussed elsewhere in this disclosure, the standing wave of uncured casting medium is likely to churn, slosh, or otherwise move in a manner that causes air bubbles to be trapped in the casting medium, potentially leading to oxygen inhibition during curing, and by extension, flawed reproduction of the relief structure of the casting master and crudding of the casting master with uncured casting media. Thus, managing the application of casting media and avoiding the creation of standing volumes of excess uncured casting media proximate to, and in contact with, a casting master remains a source of technical challenges and opportunities for improvement in the art.

Referring to the explanatory example of FIG. 2B, certain embodiments according to the present disclosure avoid the problems of waste and formation of oxygen bubbles in volumes of excess casting medium associated with indirect application of all the casting media to a substrate prior to casting through controlled applications of tuned volumes of casting medium directly to the casting master. As shown in the explanatory example of FIG. 2B, a first volume of uncured casting media 205 is applied directly to the casting master prior to introduction of a substrate. The first volume is, in certain embodiments, applied by an applicator (for example, an ink jet or other servo capable of controlled application of measured volumes of casting media). In some embodiments, the ink jet or other jetting applicator does not touch the casting master, thereby reducing the likelihood of drops of excess casting media clinging to either the ink jet or the casting master. Depending on embodiments, the first volume of uncured casting media is predetermined, for example, based on experimentation and calibration by a machine manufacturer. In some embodiments, the first volume of uncured casting media is dynamically adjusted based on image data of the cast micro-structures or other sources of feedback.

As shown in FIG. 2C, a substrate 210 is placed on top of the uncured casting material previously applied to the casting master, and section 201 of the casting master and substrate 210 are forced together, squeezing uncured casting media into the relief structures of the casting master, and squeezing out a small volume of excess casting medium to confirm full filling of the relief structures of section 201 of the casting master. In embodiments where section 201 is part of a cylindrical, or rolling casting master, the uncured casting media and the casting master may be brought together along a squeeze line, comprising a line proximate to the outer surface of the casting master and parallel to an axis of rotation of the casting master.

Once pinched between substrate 210 and section 201 of the casting master, the uncured casting medium is cured with radiation, such as ultraviolet or infrared light, causing a cross-linking reaction within the casting media. Assuming that there are no contaminants or confounding variables, such as oxygen bubbles, exposure to curing radiation causes substantially complete cross-linking of the volume of casting media to itself and substrate 210.

As shown in FIG. 2D, following successful radiation-induced cross-linking, a layer of cured casting media 211 with a relief structure that is a perfect opposite to that the casting master is formed on the surface of substrate 210. Further, and as shown in FIG. 2D, all the casting media is removed from the recesses of the casting master, allowing subsequent iterations of the casting and curing process to produce similarly flawless copies of the relief structure of the casting master.

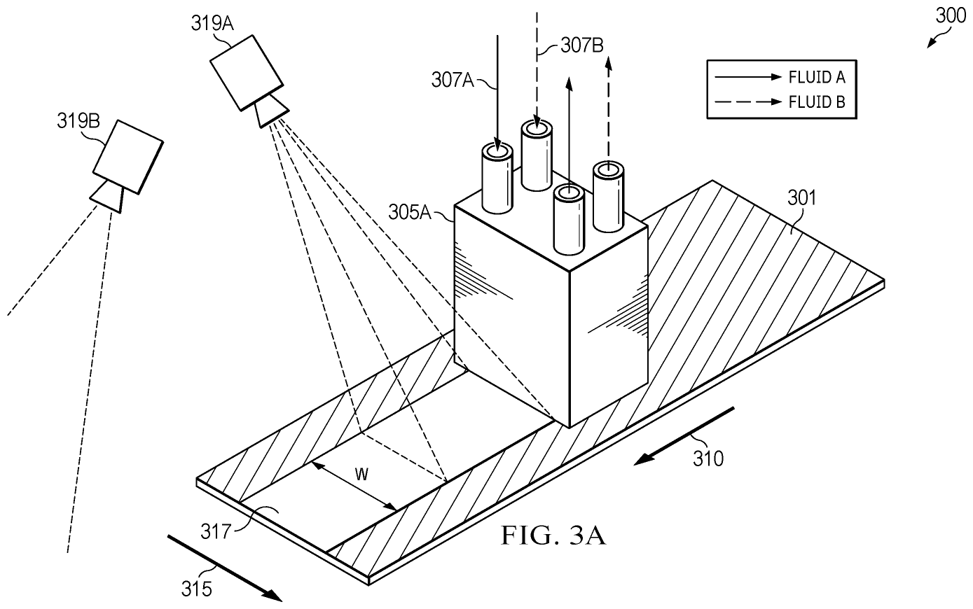

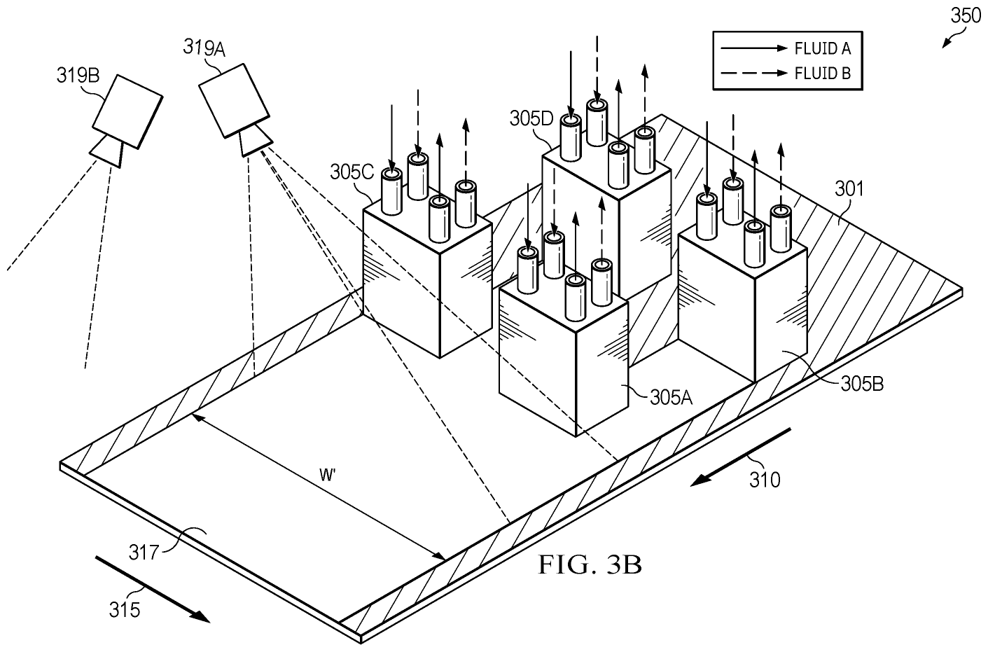

FIGS. 3A and 3B illustrate examples of a closed-circuit apparatus 300 for applying casting media to a casting master 301, according to various embodiments of this disclosure.

Referring to the illustrative example of FIG. 3A, apparatus 300 comprises one or more micro-scale jet dispensers 305A (for example, a piezo plunger device, such as an MTA Automation jet dispenser, which can dispense drop volumes of materials of varying viscosities with drop sizes as low as 0.002 mm²). According to various embodiments, each of the one or more micro-scale jet dispensers 305A may have one or more nozzles, thereby allowing more than one type of casting media to be applied to casting master 301. In the illustrative example of FIG. 3A, micro-scale jet dispenser 305A is configured to dispense a first type of fluid casting media 307A and a second type of fluid casting media 307B. Further, as casting media suitable for use in apparatus 300 comprise thermoplastic resins whose viscosity can be significantly temperature dependent, in some embodiments, casting media is cycled in and out of micro-scale jet dispenser 305A before being dispensed. In this way, the casting media can be passed through a heater to lower the viscosity of the casting media, and the rate of flow of casting media (and by implication, the current viscosity) in and out of micro-scale jet dispenser 305A can be measured.

As shown in the illustrative example of FIG. 3A, apparatus 300 is configured such that casting master 301 moves in a first direction (shown by arrow 310) relative to micro-scale jet dispenser 305A. In some embodiments, apparatus 300 comprises a stepper motor or other apparatus for moving micro-scale jet dispenser 305A forwards and backwards in the first direction over casting master 301. Alternatively, or additionally, apparatus 300 comprises a stepper motor or other apparatus for moving casting master 301 relative to micro-scale jet dispenser 305A along the first direction.

Similarly, apparatus 300 further comprises a stepper motor or other apparatus for changing the relative position of micro-scale jet dispenser 305A relative to casting master 301 in a second direction (shown by arrow 315), which is perpendicular to the first direction. Depending on embodiments, micro-scale jet dispenser 305A may be moved, or casting master 301 may be displaced. Alternatively, or additionally, micro-scale jet dispenser 305A may comprise a plurality of nozzles in a grid or raster arrangement, wherein, the area of casting master 301 upon which casting media is jetted is determined by which of the multiple nozzles is fired.

As shown in FIG. 3A, by selectively triggering one or more nozzles of micro-scale jet dispenser 305A as casting master moves relative to micro-scale jet dispenser 305A, a layer 317 of casting media is applied to fill the relief structures of casting master 301. According to various embodiments, micro-scale jet dispenser 305A jets region-specific volumes of casting media onto the various regions of casting master 301, wherein the region-specific volumes of casting media are determined based on the amount of casting media necessary to sufficiently fill the relief structures in a given area, rather than a volume sufficient to ensure that the deepest or hardest-to-wet relief structures are filled. As such, the excess casting media (as used in this disclosure, the expression “excess casting media” refers to casting media in a continuous layer above the recesses and voids of the relief structures of the casting master) in embodiments according to this disclosure can be significantly less than by indirectly applying all the casting media to a substrate and then the casting master. According to various embodiments, apparatus 300 further comprises a first inspection camera 319A, which, in some embodiments, may be a CMOS digital camera (or a manufacturing-specific sensor, such as a ROLL-2-ROLL® sensor) which passes frames of image data to one or more processing platforms operating as a controller for apparatus 300. In some embodiments, the frames of image data are analyzed by the processing platforms to assess one or more metrics of layer 317, such as an applied width w, of layer 317 on casting master 301.

In some embodiments, apparatus 300 further comprises a second, downstream vision sensor or camera 319B, which is configured to obtain frames of image data of layer 317 along a squeeze line. By measuring the width of layer 317 along the squeeze line, further information as to whether an appropriate amount of casting media is being applied to casting master 301 is being applied. As noted elsewhere in this disclosure, the viscosity of certain casting media can depend significantly on temperature. Typically, the temperature of the working surfaces (for example, casting master 301 and micro-scale jet dispenser 305A) of apparatus 300 can vary during the start of a production run, and eventually settle into an equilibrium temperature. Prior to reaching equilibrium, the variability in the temperatures of the working surfaces of apparatus 300 can affect the viscosity of applied casting media, leading to variations in width w at micro-scale jet dispenser 305A and downstream, along the squeeze line where the casting media is pressed between a substrate and the casting master. Accordingly, image data from vision sensors 319A and 319B can be used to determine, based on, for example, the observed width of layer 317 whether the working surfaces of apparatus 300 have achieved an equilibrium state (as used in this disclosure, the expression “equilibrium state” encompasses a state wherein a given volume of casting media applied to casting master 301 produces a layer 317 of casting media of consistent width). Where the image data indicates variations in the applied width of casting media, or where the image data indicates excessive or insufficient coverage of one or more regions of casting master 301, one or more casting media application parameters (for example, the temperature of the casting media or volume jetted onto casting master 301) may be adjusted to achieve a desired width at one or more of the point where casting media is applied to the casting master or where the casting media is compressed between a substrate and the casting master.

FIG. 3A provides one, non-limiting example of an apparatus according to this disclosure for controlled application of casting media to a casting master, and other embodiments are possible and within the contemplated scope of this disclosure. FIG. 3B illustrates another example of an apparatus 350 according to various embodiments of this disclosure. Referring to the illustrative example of FIG. 3B, the architecture for providing a closed loop for jetting casting media onto the surface of a casting master described with reference to FIG. 3A is extensible and can be expanded to incorporate additional instances of the components described with reference to FIG. 3A. For example, and as shown in FIG. 3B, where the optical security device is wider than what the array of nozzles in a single micro-scale jet dispenser can apply, apparatus 350 comprises a plurality of micro-scale jet dispensers 305A-305D may be used to lay down layer 317 of uncured casting media at a second width w′ that is greater than the width w achievable by a single micro-scale jet dispenser 305A. Additionally, while not shown in FIGS. 3A and 3B, apparatus 350 comprises one or more dispensers (for example, a micro-scale jet dispenser 305A) configured to apply some casting media to the substrate prior to bringing the substrate and casting master together. In some embodiments, the coverage of casting master 301 and inhibition of oxygen bubbles can be further enhanced by applying the bulk of the casting media to the casting master, but also applying some casting media to the substrate to wet the substrate. In some embodiments, 80% or more of the casting media for a given region is applied directly to the casting master and 20% or less of the casting media for a given region is applied to the substrate to which the cured and cast microstructures attach.

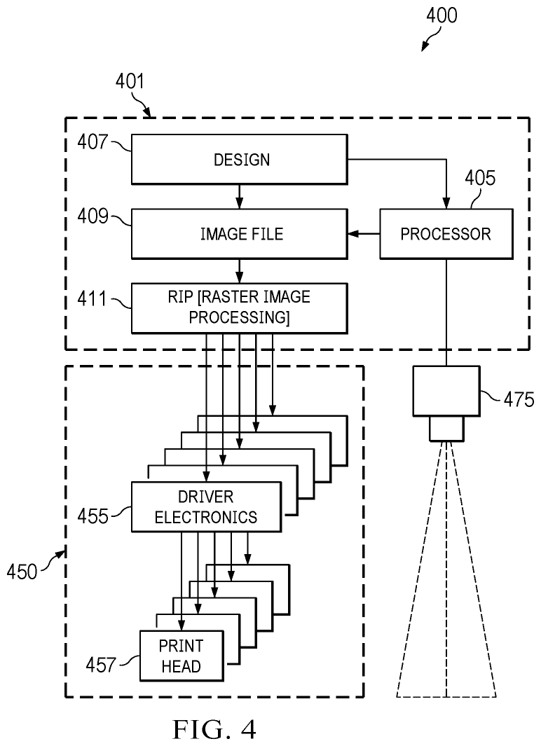

FIG. 4 illustrates, in block diagram format, an architecture 400 for performing feedback-driven application of casting media to a casting master according to various embodiments of this disclosure. Referring to the illustrative example of FIG. 4, architecture 400 comprises a controller 401, one or more casting media dispensers 450 (for example, micro-scale jet dispenser 305A in FIG. 3A) and one or more image sensors 475 (for example, camera 319A in FIG. 3A), wherein controller 401 is communicatively connected to both of casting media dispenser 450 and image sensor 475. According to various embodiments, controller 401 comprises a processor 405 configured to execute program code stored in a non-transitory memory. In some embodiments, the non-transitory memory may be integrated with processor 405. Alternatively, or additionally, the non-transitory memory may be provided on a separate chip. A memory of controller 401 or otherwise accessible to processor 405 contains a design file 407. According to various embodiments, design file 407 comprises a file specifying a base design for a pattern of one or more casting media to be jetted onto a casting master. As used in this disclosure, the expression “base design” comprises a mapping of locations on the casting master to initial volumes (i.e., volumes which have not yet been modified to account for temperature effects or variations in viscosity, or other factors affecting coverage of the casting master with casting media.).

As shown in FIG. 4, controller 401 receives image data from the one or more image sensors 475. According to various embodiments, processor 405 processes the received image data to obtain one or more visual indicia of how well casting media is being applied to the casting master. Visual indicia of the application quality of casting media include, without limitation, a measured width of a layer of casting media on a casting master (for example, width w of layer 317 in FIG. 3A), evidence of squeeze out (referring to excess casting media extending beyond a squeeze line), or the presence or absence of highlights indicating dry spots on the casting master. According to some embodiments, processor 405 modulates the mappings of volumes to regions on the casting master specified in base design file 407 based on the received image data to generate an image file 409 specifying an updated mapping of volumes of casting media to regions of the casting master. In embodiments in which casting media dispenser 450 is capable of dispensing more than one type of casting media, image file 409 further specifies a mapping of the types of casting media to applied at a given location on the casting master.

The created image file 409 is then passed to a raster image processing module 411, which renders the image file as a raster of pixels, wherein each pixel corresponds to a unique location to which a nozzle of casting media dispenser 450 can be positioned, and each pixel of the raster specifies a volume of casting media to be dispensed at the location associated with the pixel. According to some embodiments, casting media dispenser 450 moves to the pixel specified in the raster. According to various embodiments, a specific nozzle of the casting media dispenser fires when the casting master is advanced to a location corresponding to the row containing the pixel specified in the raster.

Referring to the non-limiting example of FIG. 4, the raster of pixels is passed to the driver electronics 455 of casting media dispenser 450, which translates the received pixel-level raster of volumes and mappings to locations on a casting master to control impulses to one or more print heads 457 of casting media dispenser 450.

Examples of methods of cast curing microstructures of a micro-optic security device according to present disclosure include methods including jetting a first volume of a first radiation-curable resin directly onto a casting master to form a layer of the first radiation-curable resin having a first thickness, bringing the casting master into contact with a substrate along a squeeze line to transfer the first radiation-curable resin to the substrate and applying curing radiation to the transferred first radiation-curable resin.

Examples of methods of cast curing microstructures of a micro-optic security device according to present disclosure include methods wherein the first thickness is less than a thickness necessary to wet the casting master when the first radiation-curable resin is applied to the substrate.

Examples of methods of cast curing microstructures of a micro-optic security device according to present disclosure include methods including heating the first radiation-curable resin to a first temperature before jetting the first radiation-curable resin directly onto the casting master.

Examples of methods of cast curing microstructures of a micro-optic security device according to present disclosure include methods including obtaining a width of a first line of the first radiation-curable resin transferred from the casting master to the substrate at a first time, obtaining a width of a second line of the first radiation-curable resin transferred from the casting master to the substrate at a second time and determining, based on the width of the first line and the width of the second line, whether an equilibrium between a volume of first radiation-curable resin jetted onto the casting master and line width has been achieved.

Examples of methods of cast curing microstructures of a micro-optic security device according to present disclosure include methods including responsive to determining that the equilibrium between the volume of the first radiation-curable resin jetted onto the casting master and line width has not been achieved, jetting a second volume of the first radiation-curable resin onto the casting master, wherein the second volume differs from the first volume.

Examples of methods of cast curing microstructures of a micro-optic security device according to present disclosure include methods wherein the first temperature is between 55 and 65 degrees Celsius.

Examples of methods of cast curing microstructures of a micro-optic security device according to present disclosure include methods wherein the first temperature is between 40 and 70 degrees Celsius.

Examples of methods of cast curing microstructures of a micro-optic security device according to present disclosure include methods wherein the first radiation-curable resin is jetted through a nozzle, wherein the nozzle does not touch the casting master.

Examples of methods of cast curing microstructures of a micro-optic security device according to present disclosure include methods wherein the casting master is a cylindrical casting master with a continuous relief pattern around the entire cylinder.

Examples of methods of cast curing microstructures of a micro-optic security device according to present disclosure include methods wherein the casting master is one or more of a cylindrical casting master with a discontinuous relief pattern or a flat casting master.

Examples of method of cast curing microstructures of a micro-optic security device according to the present disclosure include methods wherein the first volume is adjusted to maintain an optimum coverage area.

Examples of methods of cast curing microstructures of a micro-optic security device according to the present disclosure include methods wherein an amount of the first radiation-curable resin applied to the casting master is patterned to compensate for the amount of resin required by relief structures on the casting master.

Examples of apparatuses for cast curing microstructures of a micro-optic security device according to present disclosure include an apparatus including a jet dispenser configured to dispense a first radiation-curable resin directly onto a casting master and a controller communicatively connected to the jet dispenser, wherein the controller is configured to control the jet dispenser to dispense a first volume of the first radiation-curable resin directly onto the casting master to form a layer of the first radiation-curable resin having a first thickness.

Examples of apparatuses for cast curing microstructures of a micro-optic security device according to present disclosure include an apparatus wherein the first thickness is less than a thickness necessary to wet the casting master when the first radiation-curable resin is applied only to a substrate.

Examples of apparatuses for cast curing microstructures of a micro-optic security device according to present disclosure include an apparatus wherein the controller is configured to control the apparatus to heat the first radiation-curable resin to a first temperature before jetting the first radiation-curable resin directly onto the casting master.

Examples of apparatuses for cast curing microstructures of a micro-optic security device according to present disclosure include an apparatus including: an inspection camera configured to obtain image data of the first radiation-curable resin as applied to the casting master, wherein the controller is further configured to obtain a width of a first line of the first radiation-curable resin transferred from the casting master to a substrate at a first time, obtain a width of a second line of the first radiation-curable resin transferred from the casting master to the substrate at a second time, and determine, based on the width of the first line and the width of the second line, whether an equilibrium between a volume of first radiation-curable resin jetted onto the casting master and line width has been achieved.

Examples of apparatuses for cast curing microstructures of a micro-optic security device according to present disclosure include an apparatus wherein the controller is further configured to responsive to determining that the equilibrium between the volume of the first radiation-curable resin jetted onto the casting master and line width has not been achieved, control the jet dispenser to dispense a second volume of the first radiation-curable resin onto the casting master, wherein the second volume differs from the first volume.

Examples of apparatuses for cast curing microstructures of a micro-optic security device according to present disclosure include an apparatus wherein the first temperature is between 55 and 65 degrees Celsius.

Examples of apparatuses for cast curing microstructures of a micro-optic security device according to present disclosure include an apparatus wherein the first radiation-curable resin is dispensed through a nozzle, wherein the nozzle does not touch the casting master.

Examples of micro-optic security devices according to the present disclosure include micro-optic security devices including a substrate, one or more layers of cast-cured microstructures on the substrate, wherein the one or more layers of cast-cured microstructures a first region of cast-cured micro-structures formed of a first cured radiation-curable resin, wherein the cast-cured micro-structures in the first region are free of one or more of voids, tacky spots, or other products of oxygen inhibition.

Examples of micro-optic security devices according to the present disclosure include micro-optic security devices wherein the cast-cured micro-structures in the first region comprise a second cured radiation-curable resin.

Examples of micro-optic security devices according to the present disclosure include micro-optic security devices wherein the cast-cured micro-structures formed of the first cured radiation-curable resin comprises a first layer contacting the substrate, and wherein the cast-cured micro-structures formed of the second cured radiation-curable resin comprises a second layer contacting the first layer.

Examples of micro-optic security devices according to the present disclosure include micro-optic security devices wherein the first radiation-curable resin is one or more of an isodecyl acrylate, dipropylene glycol diacrylate, tripropylene glycol diacrylate, polyeser tetraacrylate, trimethylolpropane triacrylate, hexanediol diacrylate, acrylics, acrylated polyester, acrylated urethane, epoxy, polycarbonate, polypropylene, polyester, urethane, acrylate monomer, acrylate oligomers, O-phenlyphenoxyethyl acrylate, phenylthioethyl acrylate, bis-phenylthioethyl acrylate, cumin phenoxyl ethyl acrylate, a biphenylmethyl acrylate, bisphenol A epoxy acrylate, fluorene-type acrylate, brominated acrylate, halogenated acrylates, or a melamine acrylate.

The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

1. A method of cast curing microstructures of a micro-optic security device, the method comprising:
jetting a first volume of a first radiation-curable resin directly onto a casting master to form a layer of the first radiation-curable resin having a first thickness;
bringing the casting master into contact with a substrate along a squeeze line to transfer the first radiation-curable resin to the substrate; and
applying curing radiation to the transferred first radiation-curable resin.

2. The method of claim 1, wherein the first thickness is less than a thickness necessary to wet the casting master when the first radiation-curable resin is applied to the substrate.

3. The method of claim 1, further comprising:
heating the first radiation-curable resin to a first temperature before jetting the first radiation-curable resin directly onto the casting master.

4. The method of claim 3, further comprising:
obtaining a width of a first line of the first radiation-curable resin transferred from the casting master to the substrate at a first time;
obtaining a width of a second line of the first radiation-curable resin transferred from the casting master to the substrate at a second time; and
determining, based on the width of the first line and the width of the second line, whether an equilibrium between a volume of the first radiation-curable resin jetted onto the casting master and line width has been achieved.

5. The method of claim 4, further comprising:
responsive to determining that the equilibrium between the volume of the first radiation-curable resin jetted onto the casting master and the line width has not been achieved, jetting a second volume of the first radiation-curable resin onto the casting master,
wherein the second volume differs from the first volume.

6. The method of claim 3, wherein the first temperature is between 55 and 65 degrees Celsius.

7. The method of claim 1, wherein the first radiation-curable resin is jetted through a nozzle, wherein the nozzle does not touch the casting master.

8. An apparatus for cast curing microstructures of a micro-optic security device, the apparatus comprising:
a jet dispenser configured to dispense a first radiation-curable resin directly onto a casting master; and
a controller communicatively connected to the jet dispenser, wherein the controller is configured to:
control the jet dispenser to dispense a first volume of the first radiation-curable resin directly onto the casting master to form a layer of the first radiation-curable resin having a first thickness.

9. The apparatus of claim 8, wherein the first thickness is less than a thickness necessary to wet the casting master when the first radiation-curable resin is applied only to a substrate.

10. The apparatus of claim 8, wherein the controller is configured to control the apparatus to heat the first radiation-curable resin to a first temperature before jetting the first radiation-curable resin directly onto the casting master.

11. The apparatus of claim 10, further comprising:
an inspection camera configured to obtain image data of the first radiation-curable resin as applied to the casting master,
wherein the controller is further configured to:
obtain a width of a first line of the first radiation-curable resin transferred from the casting master to a substrate at a first time;
obtain a width of a second line of the first radiation-curable resin transferred from the casting master to the substrate at a second time; and
determine, based on the width of the first line and the width of the second line, whether an equilibrium between a volume of the first radiation-curable resin jetted onto the casting master and line width has been achieved.

12. The apparatus of claim 11, wherein the controller is further configured to:
responsive to determining that the equilibrium between the volume of the first radiation-curable resin jetted onto the casting master and the line width has not been achieved, control the jet dispenser to dispense a second volume of the first radiation-curable resin onto the casting master,
wherein the second volume differs from the first volume.

13. The apparatus of claim 10, wherein the first temperature is between 55 and 65 degrees Celsius.

14. The apparatus of claim 8, wherein the jet dispenser includes a nozzle and the first radiation-curable resin is dispensed through the nozzle, wherein the nozzle does not touch the casting master.

15. A micro-optic security device comprising:
a substrate; and
one or more layers of cast-cured microstructures on the substrate,
wherein the one or more layers of the cast-cured microstructures comprise a first region of cast-cured micro-structures formed of a first cured radiation-curable resin, and
wherein the cast-cured micro-structures in the first region are free of one or more of voids, tacky spots, or other products of oxygen inhibition.

16. The micro-optic security device of claim 15, wherein the cast-cured micro-structures in the first region comprise a second cured radiation-curable resin.

17. The micro-optic security device of claim 16, wherein the cast-cured micro-structures formed of the first cured radiation-curable resin comprises a first layer contacting the substrate, and
wherein the cast-cured micro-structures formed of the second cured radiation-curable resin comprises a second layer contacting the first layer.

18. The micro-optic security device of claim 15, wherein the first cured radiation-curable resin is one or more of an isodecyl acrylate, dipropylene glycol diacrylate, tripropylene glycol diacrylate, polyester tetraacrylate, trimethylolpropane triacrylate, hexanediol diacrylate, acrylics, acrylated polyester, acrylated urethane, epoxy, polycarbonate, polypropylene, polyester, urethane, acrylate monomer, acrylate oligomers, O-phenlyphenoxyethyl acrylate, phenylthioethyl acrylate, bis-phenylthioethyl acrylate, cumin phenoxyl ethyl acrylate, a biphenylmethyl acrylate, bisphenol A epoxy acrylate, fluorene-type acrylate, brominated acrylate, halogenated acrylates, or a melamine acrylate.
